(19) United States
(12) Patent Application Publication
(10) Pub. No.: US 2012/0178349 A1
(43) Pub. Date: Jul. 12, 2012

(54) CMP POLISHING PAD HAVING PORES FORMED THEREIN, AND METHOD FOR MANUFACTURING SAME

(75) Inventor: Chil Min Kim, Seoul (KR)

(73) Assignee: Industry-University Cooperation Foundation Sogang, Seoul (KR)

(21) Appl. No.: 13/387,399

(22) PCT Filed: Apr. 30, 2010
(86) PCT No.: PCT/KR2010/002731

§ 371 Date: Apr. 2, 2012

(30) Foreign Application Priority Data
Jul. 30, 2009 (KR) 10-2009-0069961

(51) Int. Cl. B24D 11/00; B29C 67/20

(52) U.S. Cl. 451/527; 451/526; 264/413

(57) ABSTRACT

The present invention relates to a CMP polishing pad and to a method for manufacturing same, characterized in that a light-absorbing material for forming pores is dispersed in the pad. Pores formed in the CMP polishing pad of the present invention are formed by means of the breakdown of the light-absorbing material which absorbs a laser beam irradiated on the polishing pad, enabling the pore size to be controlled by controlling the amount of the light-absorbing material, the intensity of the laser beam, etc., and enabling pore distribution to be freely controlled through the computer numerical control (CNC) technique. Accordingly, a CMP polishing pad can be provided that exhibits the highest polishing effectiveness in accordance with the material to be polished or the type of slurry.

### TECHNICAL FIELD

The present disclosure relates to a Chemical Mechanical Polishing (CMP) polishing pad and a method for manufacturing the same, and more particularly, to a CMP polishing pad having pores formed therein in order to inhibit leakage of slurry, thereby improving the stability of a CMP process and a method for manufacturing the same.

### BACKGROUND ART

Semiconductors are devices obtained by high-density integration of electronic devices such as transistors or capacitors on a semiconductor substrate such as silicon, and are fabricated by using deposition, photolithography and etching technologies. Repetition of such deposition, photolithography and etching processes results in formation of a pattern having a specific shape. When the formation of patterns is repeated in a layered structure, a level difference gradually becomes severe at the top of the resultant structure. Such a severe level difference at the top of the structure makes the focus of a photomask pattern unclear in the subsequent photolithography process, thereby making it difficult to form a fine pattern.

One of the technologies including reducing the level difference on a substrate to increase resolution in photolithography is Chemical Mechanical Polishing (CMP). CMP includes polishing a substrate having a level difference mechanically and chemically to planarize the top of the substrate. FIG. 1 is a schematic view illustrating a CMP process. Referring to FIG. 1, the CMP process is carried out by allowing a wafer 103 to rotate while being in contact with a rotating CMP polishing pad 102 so that the layer formed on the top of a wafer 103 may be polished. The CMP polishing pad 102 is bound to a rotating flat table 101 and the wafer 103 is rotated while being in contact with the CMP polishing pad 102 by way of a carrier 104. Herein, slurry 106 is supplied from a slurry feed nozzle 105 to the top of the CMP polishing pad 102.

CMP polishing pads are consumable goods for use in polishing wafer surfaces and are essential for CMP processes. The slurry is present between the CMP polishing pad and the wafer surface during CMP to carry put chemical mechanical polishing of the wafer surface. Then, the used slurry is discharged to the exterior. To retain the slurry on the CMP polishing pad for a predetermined time, it is required for the CMP polishing pad to store the slurry thereon. Such slurry storability of the CMP polishing pad may be obtained by pores or holes formed on the polishing pad. In other words, the slurry is introduced into the pores or holes formed on the CMP polishing pad so that the semiconductor surface may be polished efficiently for a long time. In order to ensure that the CMP polishing pad inhibits leakage of the slurry and provides high polishing efficiency, it is required that the shapes of the pores or holes are controlled well and the physical properties, such as hardness, of the polishing pad are maintained in an optimized condition.

Conventional CMP polishing pads have been obtained by forming pores with an irregular size and arrangement inside polishing pads by a physical or chemical method. FIG. 2 is a sectional view showing a CMP polishing pad obtained according to the related art. Referring to FIG. 2, pores 102a having various shapes and sizes are arranged in a randomly distributed form on the surface or inside of a polishing pad 102 made of polymer.

One of the physical methods among the conventional methods for forming pores or holes on a CMP polishing pad is mixing a micro-sized material with a material for forming a polishing pad. In this case, it is required that a porous micro-sized material is placed in such a manner that it may be mixed well with a polishing pad material at the initial time of polishing pad fabrication. However, it is difficult to allow the micro-sized material to be mixed well with the polishing pad material by a physical method. Moreover, the micro-sized material is not uniform in size. In general, the average pore diameter of pores formed by a physical method is about 100 micrometers, but each pore has a diameter ranging from several tens micrometers to several hundreds micrometers. This results from a technical limitation in forming the pores. In addition, when fabricating a polishing pad, pores are randomly distributed at different positions due to the gravity. Thus, it is difficult to obtain a polishing pad having uniform quality. When the pores formed on the CMP polishing pad are not uniform in size or distribution, the polishing efficiency varies with position or time while a wafer is polished with a high precision.

One of the chemical methods for forming pores on a CMP polishing pad uses water or liquid capable of being converted into gas. When water or such liquid is introduced to polyurethane solution and then heated, pores are formed while the liquid is converted into gas. However, such a method for forming pores by using gas is still problematic in that maintenance of a uniform pore size is difficult. Therefore, there has been a need for developing a method for maintaining a uniform shape of the pores or holes formed on a CMP polishing pad and controlling the distribution of pores or holes as desired.

### DISCLOSURE

### Technical Problem

The present disclosure is directed to providing a CMP polishing pad having pores formed therein, wherein the pores have a controlled size and distribution.

The present disclosure is also directed to providing a method for manufacturing a CMP polishing pad having pores formed therein, wherein the pores have a controlled size and distribution.

### Technical Solution

In one general aspect, the present disclosure provides a CMP polishing pad in which light-absorbing materials for forming pores are dispersed.

According to an embodiment, the pores may be formed by breakdown of the light-absorbing materials that have absorbed laser beams irradiated to the polishing pad, and the pores may have a size determined by the intensity of the laser beams or the size of the light-absorbing materials.

According to another embodiment, the light-absorbing materials may include carbon particles.

According to still another embodiment, the carbon particles may be fullerence. According to still another embodiment, the light-absorbing materials may include a powder dye.

According to still another embodiment, the pores may have a diameter of 10-500 micrometers.

According to still another embodiment, the light-absorbing materials may have a diameter of 1-300 micrometers.

According to yet another embodiment, the pores may be classified into a plurality of groups based on pore diameters.

In a variant, the present disclosure provides a CMP polishing pad having a plurality of pores formed therein, wherein the pores are formed by breakdown of light-absorbing materials dispersed in the CMP polishing pad in the presence of laser beams.

According to an embodiment, the light-absorbing materials may absorb light in a wavelength range of the laser beams.

According to another embodiment, the laser beams may be generated by a pulse laser.

In another general aspect, the present disclosure provides a method for manufacturing a CMP polishing pad, including: dispersing light-absorbing materials in a CMP polishing pad; and irradiating the CMP polishing pad in which the light-absorbing materials are dispersed with laser beams to form pores in the CMP polishing pad, wherein the pores are formed by breakdown of the light-absorbing materials caused by the laser beams.

According to an embodiment, the pores may have a size determined by the intensity of the laser beams or the size of the light-absorbing materials.

According to another embodiment, the light-absorbing materials may include carbon particles.

According to still another embodiment, the pores formed in the CMP polishing pad may have a spatial distribution determined by controlling relative positions of the laser beams and the CMP polishing pad.

### Advantageous Effects

The CMP polishing pad disclosed herein uses light-absorbing materials having a controlled size and the light-absorbing materials are dispersed in the CMP polishing pad. The CMP polishing pad has pores formed by breakdown of the light-absorbing material through the control of the intensity of laser beams. Thus, it is possible to freely control the size of pores formed in the CMP polishing pad. Further, it is possible to form pores with a desired distribution in the CMP polishing pad by varying relative positions of the laser beams and CMP polishing pad via a computer numerical control (CNC) process. As a result, it is possible to carry out a CMP process with high polishing efficiency and high process stability, depending on the type of a material to be polished or the composition of slurry.

### DESCRIPTION OF DRAWINGS

The above and other objects, features and advantages of the present disclosure will become apparent from the following description of certain exemplary embodiments given in conjunction with the accompanying drawings, in which:

FIG. 1 is a schematic view showing a CMP process;

FIG. 2 is a sectional view of a CMP polishing pad obtained according to the related art;

FIG. 3 is a schematic view showing how to form pores in a CMP polishing pad by laser beams;

FIG. 4 shows sectional views of a CMP polishing pad (portion (a)) in which uniform-sized light-absorbing materials are dispersed and CMP polishing pads (portions (b) and (c)) having pores formed with various shapes by laser beams;

FIG. 5 shows sectional views of a CMP polishing pad (portion (a)) in which light-absorbing materials having different sizes are dispersed and CMP polishing pads (portions (b) and (c)) having pores formed with various shapes by laser beams; and

FIG. 6 shows how to control the distribution of the pores formed in a CMP polishing pad by adjusting relative positions of laser beams and the CMP polishing pad via a computer numerical control (CNC) process.

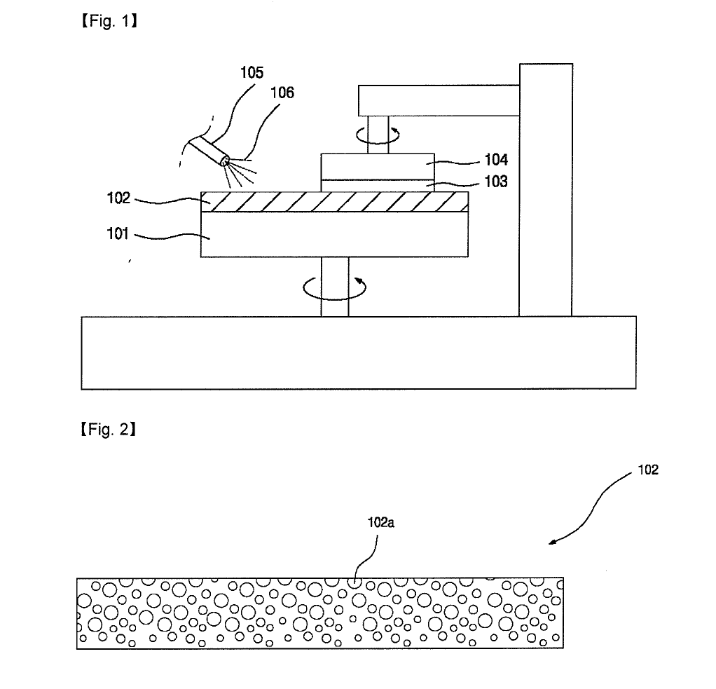

### BEST MODE

Hereinafter, the embodiments of the present disclosure will be described in detail with reference to accompanying drawings.

The CMP polishing pad disclosed herein includes light-absorbing materials for forming pores, wherein the light-absorbing materials are dispersed in the CMP polishing pad, pores are formed by breakdown of the light-absorbing materials that have absorbed laser beams irradiated to the polishing pad, and sizes of the pores are determined by the intensity of the laser beams or the size of the light-absorbing materials.

The pores formed in the CMP polishing pad are obtained by the light-absorbing materials dispersed in the polishing pad and laser beams. The light-absorbing materials absorb the laser beams and undergo an increase in temperature by themselves, resulting in instant vaporization. Otherwise, such an increase in temperature causes instant vaporization of the surrounding polymer material to assist formation of pores. Such a microscopic explosion of the light-absorbing materials caused by light absorption is referred to as breakdown.

FIG. 3 is a schematic view showing how to form pores in a CMP polishing pad by laser beams. Referring to FIG. 3, when laser beams 302 are irradiated to the CMP polishing pad in which light-absorbing materials 301 are dispersed, the light-absorbing materials present at the regions to which the laser beams are irradiated absorb the light, thereby causing a breakdown phenomenon. Due to the breakdown phenomenon, pores are formed in the CMP polishing pad. Herein, the thus formed pores have a size that is in proportion to the size of the light-absorbing materials and to the intensity of the laser beams. Therefore, it is possible to form a plurality of size-controlled pores by adjusting the size of the light-absorbing materials or the intensity of the laser beams. Since the pores formed as mentioned above have a predetermined controlled size in the CMP polishing pad, it is possible to improve polishing efficiency.

The light-absorbing materials absorb light in the wavelength range of the laser beams. Particularly, the materials used in the polishing pad and the wavelength range of the laser beams may be selected in such a manner that the polymer material, such as polyurethane, forming the polishing pad absorbs less or no light in the wavelength range of the laser beams and the light-absorbing materials absorb light well in the same wavelength range. The light-absorbing materials are controlled to have a predetermined size and may be carbon particles or powder dye having a predetermined diameter. The carbon particles may include fullerence formed by binding of a plurality of carbon atoms in the form of a soccer ball. Fullerence may be classified into C60, C70, C240 or C540 according to carbon numbers participating in binding, and all of them may be used as the light-absorbing material in the present disclosure. Fullerence has a different diameter depending on carbon numbers, and thus is useful as a light-absorbing material for controlling the diameter of pores. In addition, the light-absorbing material may be a dye and any known dyes may be used as long as they are not dissolved into polymers but dispersed in the form of particles.

The pores formed in the CMP polishing pad may have a uniform size and distribution. When the pores have a random size distribution or an irregular spatial distribution, the overall polishing uniformity is degraded and a higher or lower polishing rate appears at some regions, resulting in degradation of process stability. In addition, the material to be polished may have different thicknesses in a wafer, or in some cases, a different polishing rate may be required at a certain region due to a loading effect in a CMP process. Therefore, it is sometimes required to control the size and distribution of the pores to a predetermined pattern depending on the level difference formed in the underlying layer.

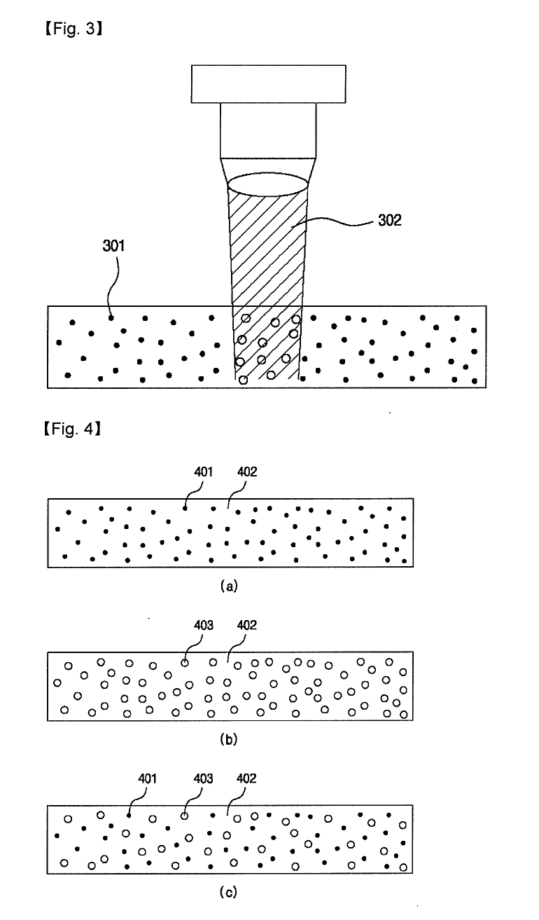

FIG. 4 shows sectional views of a CMP polishing pad (portion (a)) in which uniform-sized light-absorbing materials are dispersed and CMP polishing pads (portions (b) and (c)) having pores formed with various shapes by laser beams.

Portion (a) of FIG. 4 shows a sectional view of a CMP polishing pad in which uniform-sized light-absorbing materials are dispersed. Referring to portion (a) of FIG. 4, uniform-sized light-absorbing materials 401 are dispersed in the polishing pad 402 in the form of particles. Methods for dispersing light-absorbing materials in a CMP polishing pad include dispersing particle-like light-absorbing materials into materials forming the polishing pad before the polymerization thereof or into molten materials for forming the polishing pad. Herein, to allow uniform dispersion of the light-absorbing materials, ultrasonic wave generators may be used. The light-absorbing materials 401 may have a particle size related to the size of the pores to be formed after the irradiation of laser beams and may be controlled to different sizes. The density of the dispersed light-absorbing materials is related with the number of pores, and may be controlled freely according to desired physical properties of the polishing pad.

Portion (b) of FIG. 4 shows an embodiment of a CMP polishing pad having pores formed by irradiating laser beams to the CMP polishing pad in which uniform-sized light-absorbing materials are dispersed. Referring to portion (b) of FIG. 4, the light-absorbing materials dispersed in the polishing pad 402 are converted totally into pores 403. Under a constant intensity of the laser beams irradiated to the polishing pad, the pore size is in proportion to the size of the light-absorbing materials. When uniform-sized light-absorbing materials are dispersed, the pore size is in proportion to the intensity of the laser beams. When the light-absorbing materials dispersed in the CMP polishing pad are converted totally into pores, the dispersion density of the light-absorbing materials becomes the dispersion density of the pores.

Portion (c) of FIG. 4 shows another embodiment of a CMP polishing pad having pores formed by irradiating laser beams to the CMP polishing pad in which uniform-sized light-absorbing materials are dispersed. Referring to portion (c) of FIG. 4, the light-absorbing materials 401 dispersed in the CMP polishing pad 402 are converted partially into pores. When laser beams are irradiated to the polishing pad, all of the light-absorbing materials present within the range of diameters of laser beams undergo breakdown. However, for the purpose of convenience, FIG. 4 shows the light-absorbing materials and the pores dispersed randomly in the polishing pad. Such a structure may be formed when laser beams are not irradiated to the whole area of the polishing pad but to partial regions locally. When forming the pores in such a structure, the dispersion of the pores is not determined by the dispersion of the light-absorbing materials. Rather, it is possible to control the dispersion of the pores by the irradiation of laser beams. In other words, it is possible to increase or decrease the pore density intentionally at the central portion or outer portion of the CMP polishing pad.

The pores formed in the CMP polishing pad may have a diameter of 10-500 μm. The pore size is a parameter related to the degree of retaining slurry through a capillary phenomenon. Therefore, the pore size may be controlled in a wide range according to the pressure applied to the CMP polishing pad and particular types of slurry and materials to be polished. When the pore size is less than 10 μm, it is difficult to control the pore size through breakdown. On the other hand, when the pore size is greater than 500 μm, it is difficult for the pores to retain slurry. The pore size is in proportion to the size of the light-absorbing materials. To satisfy the above-defined range of pore diameters, the light-absorbing materials may have a diameter of 1-300 μm.

The density and distribution of the pores formed in the CMP polishing pad affect not only the degree of retaining slurry of the polishing pad but also the hardness of the polishing pad itself. In other words, a higher pore density of the CMP polishing pad causes lower hardness of the polishing pad, resulting in a drop in pressure applied to a wafer to be polished, and vice versa.

A CMP process includes physical polishing and chemical polishing at the same time. It can be said that the pore size affects chemical polishing more significantly and the pore density affects physical polishing more significantly. Therefore, according to the present disclosure, it is possible to control the size and density of the pores formed in the CMP polishing pad according to the size and dispersion density of the light-absorbing materials. Further, it is possible to control the distribution of the pores according to the irradiation of laser beams. As a result, it is possible to control internal parameters related to CMP as desired.

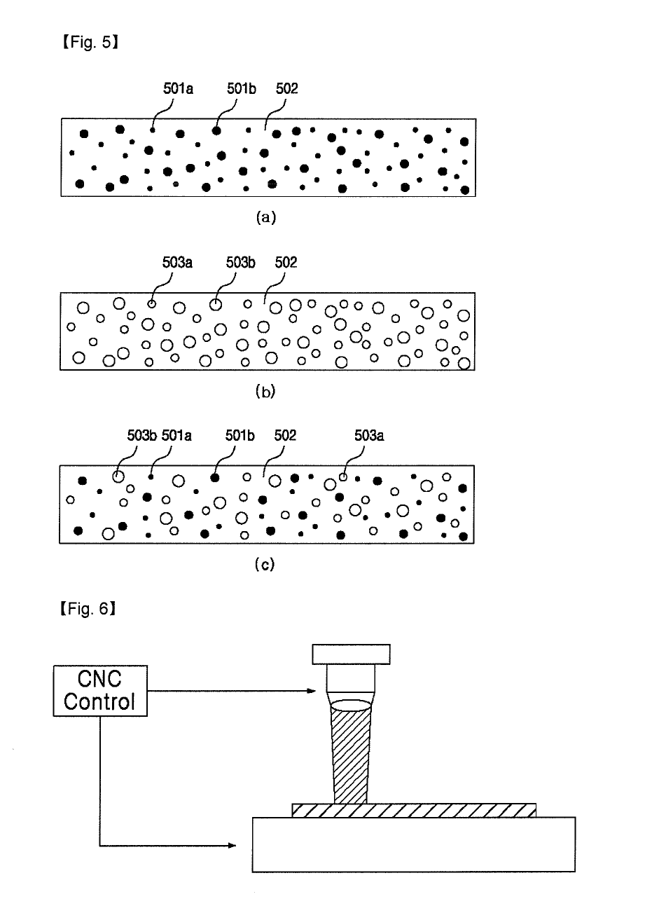

FIG. 5 shows sectional views of a CMP polishing pad (portion (a)) in which light-absorbing materials having different sizes are dispersed and CMP polishing pads (portions (b) and (c)) having pores formed with various shapes by laser beams.

Portion (a) of FIG. 5 shows a sectional view of a CMP polishing pad in which light-absorbing materials having different sizes are dispersed. Referring to portion (a) of FIG. 5, light-absorbing materials 501a having a relatively small particle size and light-absorbing materials 501b having a relatively large particle size are dispersed in the polishing pad 502. When irradiating laser beams having the same intensity, pores having a relatively large diameter are formed in the region having the large-diameter light-absorbing materials, while pores having a relatively small diameter are formed in the region having the small-diameter light-absorbing materials.

Portion (b) of FIG. 5 shows an embodiment of a CMP polishing pad having pores formed by irradiating laser beams to the CMP polishing pad in which light-absorbing materials having different sizes are dispersed. Referring to portion (b) of FIG. 5, the light-absorbing materials dispersed in the CMP polishing pad are converted totally into pores, wherein pores 503a having a relatively small diameter and pores 503b having a larger diameter are distributed. Such combined small-diameter pores and large-diameter pores in the polishing pad allow polishing characteristics controlled over a wide range. In other words, it is possible to provide a CMP polishing pad satisfying polishing characteristics favored by small-diameter pores and those favored by large-diameter pores at the same time. In FIG. 5, two different pore sizes are shown but multiple groups of pores classified on the basis of size are also included in the scope of the present disclosure. Such pores may be obtained by dispersing multiple groups of light-absorbing materials classified on the basis of size into the polishing pad.

Portion (c) of FIG. 5 shows another embodiment of a CMP polishing pad having pores formed by irradiating laser beams to the CMP polishing pad in which light-absorbing materials having different sizes are dispersed. Referring to portion (c) of FIG. 5, the light-absorbing materials 501a, 501b dispersed in the CMP polishing pad 402 are converted partially into pores 503a, 503b. Such a structure may be formed by irradiating laser beams partially to the polishing pad, and the pore distribution may be controlled according to the irradiation of laser beams. When forming pores in a CMP polishing pad in the above-mentioned manner, it is possible to control the size and distribution of pores over a wider range of parameters.

The distribution of the pores formed in the CMP polishing pad may be determined by controlling relative positions of the laser beams and the CMP polishing pad. The pores may be distributed in such a manner that the pore density is higher or lower at the central portion or outer portion of the CMP polishing pad. This may be accomplished by controlling the diameter of laser beams or the number of irradiation times. In other words, irradiation of laser beams with a relatively larger diameter or with a larger number of irradiation times provides higher pore density, and vice versa. Increasing the number of laser beam irradiation times means increasing the number of laser beam irradiation times at a different site of the polishing pad.

FIG. 6 shows how to control the distribution of the pores formed in a CMP polishing pad by adjusting relative positions of laser beams and the CMP polishing pad via a computer numerical control (CNC) process. Referring to FIG. 6, distribution of pores to be formed in a polishing pad is determined first, and then programmed to control the mobile mechanism attached to the laser unit or CMP polishing pad through a CNC process. In this manner, it is possible to form pores in the CMP polishing pad in a desired shape of distribution.

The laser units used for carrying out breakdown of the light-absorbing materials according to the present disclosure include various types of laser units. Both continuous wave lasers and pulse lasers may be used. Particularly, pulse lasers irradiate laser beams with higher output in a shorter time as compared to continuous wave lasers, and thus are favorable to instant breakdown. Particular examples of pulse lasers that may be used include various types of lasers, such as Q-switching lasers, mode-locked lasers or femtosecond lasers.

1. A CMP polishing pad in which light-absorbing materials for forming pores are dispersed.

2. The CMP polishing pad according to claim 1, wherein the pores are formed by breakdown of the light-absorbing materials that have absorbed laser beams irradiated to the polishing pad, and sizes of the pores are determined by intensity of the laser beams or size of the light-absorbing materials.

3. The CMP polishing pad according to claim 1, wherein the light-absorbing materials include carbon particles.

4. The CMP polishing pad according to claim 3, wherein the carbon particles are fullerence.

5. The CMP polishing pad according to claim 1, wherein the light-absorbing materials include a dye.

6. The CMP polishing pad according to claim 1, wherein the pores have a diameter of 10-500 micrometers.

7. The CMP polishing pad according to claim 1, wherein the light-absorbing materials have a diameter of 1-300 micrometers.

8. The CMP polishing pad according to claim 1, wherein the pores are classified into a plurality of groups based on pore diameters.

9. A CMP polishing pad having a plurality of pores formed therein, wherein the pores are formed by breakdown of light-absorbing materials dispersed in the CMP polishing pad in the presence of laser beams.

10. The CMP polishing pad according to claim 9, wherein the light-absorbing materials absorb light in a wavelength range of the laser beams.

11. The CMP polishing pad according to claim 9, wherein the laser beams are generated by a pulse laser.

12. A method for manufacturing a CMP polishing pad, comprising:
dispersing light-absorbing materials in a CMP polishing pad; and
irradiating the CMP polishing pad in which the light-absorbing materials are dispersed with laser beams to form pores in the CMP polishing pad, wherein the pores are formed by breakdown of the light-absorbing materials caused by the laser beams.

13. The method for manufacturing a CMP polishing pad according to claim 12, wherein sizes of the pores are determined by intensity of the laser beams or size of the light-absorbing materials.

14. The method for manufacturing a CMP polishing pad according to claim 12, wherein the light-absorbing materials include carbon particles.

15. The method for manufacturing a CMP polishing pad according to claim 12, wherein the pores formed in the CMP polishing pad have a spatial distribution determined by controlling relative positions of the laser beams and the CMP polishing pad.
